(19) United States
(12) Patent Application Publication
(10) Pub. No.: US 2008/0024772 A1
(43) Pub. Date: Jan. 31, 2008

(54) Particle removal tool with integrated defect detection/analysis capability

(75) Inventors: Li-Ping Wang, Fremont, CA (US); David S. Kuo, Palo Alto, CA (US); Sophia A. Fujioka, Fremont, CA (US); Jianmin Wang, Fremont, CA (US)

Correspondence Address: Seagate Technology;c/o DARBY & DARBY P.C., P.O. Box 770, Church Street Station, New York, NY, 10008-0770, US

(73) Assignee: SEAGATE TECHNOLOGY LLC, Scotts Valley, CA (US)

(21) Appl. No.: 11/492,798

(22) Filed: Jul. 26, 2006

(51) Int. Cl. G01N 21/00

(52) U.S. Cl. 356/237.2

(57) ABSTRACT

An integrated unit comprising a particle detection tool and a particle removal tool combined as one merged tool comprising a disc mounting mechanism having a mount for mounting the disc for both particle detection and particle removal, wherein the particle detection tool is adapted to distinguish between a fixed defect in the disc and a particle on the disc is disclosed herein. Also, the methods of manufacturing the integrated unit and using the integrated unit for detect detection and analysis are disclosed herein.

### RELATED APPLICATION

This application is related to U.S. Pat. Nos. 7,028,743, 6,987,627, 6,985,314 and 6,979,524, which are incorporated herein by reference.

### FIELD OF INVENTION

The present invention relates to disc drive systems, and more particularly, to method and apparatus for particle removal tool with integrated defect detection/analysis capability.

### BACKGROUND

Magnetic and magneto-optical (MO) recording media are widely used in various applications, e.g., in hard disk form, particularly in the computer industry, for storage and retrieval of large amounts of data/information. Typically such media require pattern formation in the major surface(s) thereof for facilitating operation, e.g., servo pattern formation for enabling positioning of the read/write transducer head over a particular data band or region.

Magnetic and MO recording media are conventionally fabricated in thin film form; the former are generally classified as “longitudinal” or “perpendicular”, depending upon the orientation (i.e., parallel or perpendicular) of the magnetic domains of the grains of the magnetic material constituting the active magnetic recording layer, relative to the surface of the layer.

In operation of magnetic media, the magnetic layer is locally magnetized by a write transducer or write head to record and store data/information. The write transducer creates a highly concentrated magnetic field which alternates direction based on the bits of information being stored. When the local magnetic field applied by the write transducer is greater than the coercivity of the recording medium layer, then the grains of the polycrystalline magnetic layer at that location are magnetized. The grains retain their magnetization after the magnetic field applied by the write transducer is removed. The direction of the magnetization matches the direction of the applied magnetic field. The pattern of magnetization of the recording medium can subsequently produce an electrical response in a read transducer, allowing the stored medium to be read.

FIG. 1 shows a schematic plan view of a magnetic recording disk 30 (of either longitudinal or perpendicular type) having a data zone 34 including a plurality of servo tracks, and a contact start/stop (CSS) zone 32. A servo pattern 40 is formed within the data zone 34, and includes a number of data track zones 38 separated by servo tracking zones 36. The data storage function of disk 30 is confined to the data track zones 38, while servo tracking zones 36 provide information to the disk drive which allows a read/write head to maintain alignment on the individual, tightly-spaced data tracks.

On each track, multiple “bits” (typically eight) form one “byte” and bytes of data are grouped as sectors. Reading or writing a sector requires knowledge of the physical location of the data in the data zone so that the servo-controller of the disk drive can accurately position the read/write head in the correct location at the correct time. Most disk drives use disks with embedded “servo patterns” of magnetically readable information. The servo patterns are read by the magnetic head assembly to inform the disk drive of track location. In conventional disk drives, tracks typically include both data sectors and servo patterns and each servo pattern typically includes radial indexing information, as well as a “servo burst”. A servo burst is a centering pattern to precisely position the head over the center of the track. Because of the locational precision needed, writing of servo patterns requires expensive servo-pattern writing equipment and is a time consuming process.

Commonly assigned, co-pending U.S. patent application Ser. No. 10/082,178 (the '178 application), filed Feb. 26, 2002, the entire disclosure of which is incorporated herein by reference, discloses a method and apparatus for reliably, rapidly, and cost-effectively forming very sharply defined magnetic transition patterns in a magnetic medium containing a longitudinal or perpendicular type magnetic recording layer without requiring expensive, complicated servo writing equipment/techniques incurring long processing intervals. Specifically, the invention disclosed in U.S. patent application Ser. No. 10/082,178 is based upon recognition that a stamper/imprinter comprised of a magnetic material having a high saturation magnetization, Bₛₐₜ, i.e., Bₛₐₜ≧0.5 Tesla, and a high permeability, μ, i.e., μ≧5, e.g., selected from Ni, NiFe, CoNiFe, CoSiFe, CoFe, and CoFeV, can be effectively utilized as a contact “stamper/imprinter” for contact “imprinting” of a magnetic transition pattern, e.g., a servo pattern, in the surface of a magnetic recording layer of a magnetic medium (“workpiece”), whether of longitudinal or perpendicular type. A key feature of the invention of the '178 application is the use of a stamper/imprinter having an imprinting surface including a topographical pattern, i.e., comprised of projections and depressions corresponding to a desired magnetic transition pattern, e.g., a servo pattern, to be formed in the magnetic recording layer.

Stampers/imprinters for use in a typical application, e.g., servo pattern formation in the recording layer of a disk-shaped, thin film, longitudinal or perpendicular magnetic recording medium comprise an imprinting surface having topographical features consisting of larger area data zones separated by smaller areas with well-defined patterns of projections and depressions corresponding to conventionally configured servo sectors, as for example, disclosed in commonly assigned U.S. Pat. No. 5,991,104, the entire disclosure of which is incorporated herein by reference. For example, a suitable topography for forming the servo sectors may comprise a plurality of projections (alt. depressions) having a height (alt. depth) in the range from about 100 to about 500 nm, a width in the range from about 50 to about 500 nm, and a spacing in the range from about 50 to about 500 nm.

According to the invention of the '178 application, the magnetic domains of the magnetic recording layer of the workpiece are first unidirectionally aligned (i.e., “erased” or “initialized”), as by application of a first external, unidirectional magnetic field Hᵢₙᵢₜᵢₐₗ of first direction and high strength greater than the saturation field of the magnetic recording layer, typically ≧2,000 and up to about 20,000 Oe. The imprinting surface of the stamper/imprinter is then brought into intimate (i.e., touching) contact with the surface of the magnetic recording layer. With the assistance of a second externally applied magnetic field of second, opposite direction and lower but appropriate strength H_{re-align}, determined by Bₛₐₜ/μ of the stamper material (typically ≧100 Oe, e.g., from about 2,000 to about 4,500 Oe), the alignment of the magnetic domains at the areas of contact between the projections of the imprinting surface of the stamper/imprinter (in the case of perpendicular recording media, as schematically illustrated in FIG. 2) or at the areas facing the depressions of the imprinting surface of the stamper/imprinter (in the case of longitudinal recording media, as schematically illustrated in FIG. 3) and the magnetic recording layer of the workpiece is selectively reversed, while the alignment of the magnetic domains at the non-contacting areas (defined by the depressions in the imprinting surface of the stamper/imprinter) or at the contacting areas, respectively, is unaffected, whereby a sharply defined magnetic transition pattern is created within the magnetic recording layer of the workpiece to be patterned which essentially mimics the topographical pattern of projections and depressions of the imprinting surface. According to the invention, high Bₛₐₜ and high μ materials are preferred for use as the stamper/imprinter in order to: (1) avoid early magnetic saturation of the stamper/imprinter at the contact points between the projections of the imprinting surface and the magnetic recording layer, and (2) provide an easy path for the magnetic flux lines which enter and/or exit at the side edges of the projections.

According to conventional methodology, stampers/imprinters suitable for use in performing the foregoing patterning processes are manufactured by a sequence of steps as schematically illustrated in cross-sectional view in FIG. 4, which steps include providing a “master” comprised of a substantially rigid substrate with a patterned layer of a resist material thereon, the pattern comprising a plurality of projections and depressions corresponding (in positive or negative image form, as necessary) to the desired pattern to be formed in the surface of the stamper/imprinter. Stampers/imprinters are made from the master by initially forming a thin, conformal layer of an electrically conductive, magnetic material (e.g., Ni) over the patterned resist layer and then electroforming a substantially thicker (“blanket”) magnetic layer (of the aforementioned magnetic metals and/or alloys) on the thin layer of electrically conductive material, which electroformed blanket layer replicates the surface topography of the resist layer. Upon completion of the electroforming process, the stamper/imprinter is separated from the master, which is then re-used for making additional stampers/imprinters.

Particle removal from the surface of the media during the stamping and replication procedure is an important step. It removes loose particles that are generally present on media surfaces in the back end process of media manufacturing. These particles are considered detrimental to the stamper life in the replication procedure. In order to achieve high throughput and efficiency of particle removal, instant knowledge of the outcome of the particle removal process is necessary while the disc is mounted on the mount for burnishing (particle removal) of media surfaces. Current approach is to have a stand-alone particle inspection unit, separate from the particle removal unit, performing defect detection (by optical means or others) as feedback to the particle removal process. Two problems are encountered in this approach: (1) Disc handling in between the particle removal tool and the inspection tool sometimes contaminates the discs. (2) Current particle inspection tool detects all types of defects including non-removable ones on the media surface such as voids, pits, scratches etc. Some of these defects are not considered harmful to the stamper in the replication procedure. Particle inspection tool alone cannot distinguish different types of defects and would over reject media if only non-harmful defects being detected on media.

### SUMMARY OF THE INVENTION

An embodiment of the invention relates to an integrated unit comprising a particle detection tool and a particle removal tool combined as one merged tool comprising a disc mounting mechanism having a mount for mounting the disc for both particle detection and particle removal, wherein the particle detection tool is adapted to distinguish between a fixed defect in the disc and a particle on the disc. Preferably, particle removal tool comprises a burnishing head. Preferably, the particle removal tool comprises a tape-containing buffing tool. Preferably, the burnishing head is skewed to a surface of disc. Preferably, the particle detection tool comprises an optics module and a system integrator comprising software algorithm. Preferably, the optics module comprises an incident beam generator that directs a beam of light on a surface of the disc and a detector that captures light scattered from the fixed defect in the disc and the particle on the disc. Preferably, the detector is a line scan camera. Preferably, the optics module is adapted to detect said fixed defect or said particle having a dimension of about 0.1 micron or more. Preferably, the system integrator compares optical defect maps of a surface of the disc before and after a particle removal process to distinguish said fixed defect from said particle. The integrated unit could further comprise a stamper. Preferably, the fixed defect is a void, a pit, a target spit, a blister, a scratch, or a handling defect.

Another embodiment of the invention relates to a method of defect detection and analysis with an integrated unit comprising a particle detection tool and a particle removal tool combined as one merged tool comprising a disc mounting mechanism having a mount for mounting the disc for both particle detection and particle removal, wherein the method comprises mounting the disc on the mount, detecting a fixed defect in the disc and a particle on the disc, and distinguishing between the fixed defect in the disc and the particle on the disc. The method could further comprise rotating the disc and sweeping a burnishing heading across a surface of the disc. Preferably, the burnishing head is swept across the surface of the disc at a skewed angle with respect to the surface of the disc. Preferably, the burnishing head is attached to an arm having a central axis, the arm being translated in a sweeping manner and being skewed relative to the surface of the disc. Preferably, the burnishing head is skewed by an angle of between about 5° to about 30°. The method could further comprise monitoring a safety sensor, communicating to an external device and adhering to equipment manufacturing safety standards and operations.

Yet another embodiment of the invention relates to a method of manufacturing an integrated unit comprising integrating a particle detection tool and a particle removal tool as one merged tool and attaching a disc mounting mechanism having a mount for mounting a disc for both particle detection and particle removal, wherein the particle detection tool is adapted to distinguish between a fixed defect in the disc and a particle on the disc. Preferably, the particle detection tool comprises an optics module comprising an optical inspection system. The method could further comprise assembling a controller or computer to control data operation and processing of the particle removal tool, to control the optical inspection system and to control a disc spindle of the disc mounting mechanism.

As will be realized, this invention is capable of other and different embodiments, and its details are capable of modifications in various obvious respects, all without departing from this invention. Accordingly, the drawings and description are to be regarded as illustrative in nature and not as restrictive.

### BRIEF DESCRIPTION OF THE DRAWINGS

FIG. 1 illustrates in simplified, schematic plan view, a magnetic recording disk designating the data, servo pattern, and CSS zones thereof.

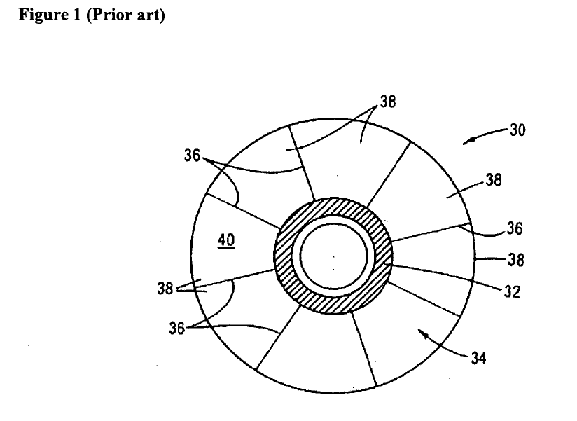

FIG. 2 illustrates, in schematic, simplified cross-sectional view, a sequence of process steps for contact printing a magnetic transition pattern in the surface of a perpendicular magnetic recording layer, utilizing a stamper/imprinter formed of a high saturation magnetization (Bₛₐₜ), high permeability (μ) magnetic material having an imprinting surface with a surface topography corresponding to the desired magnetic transition pattern.

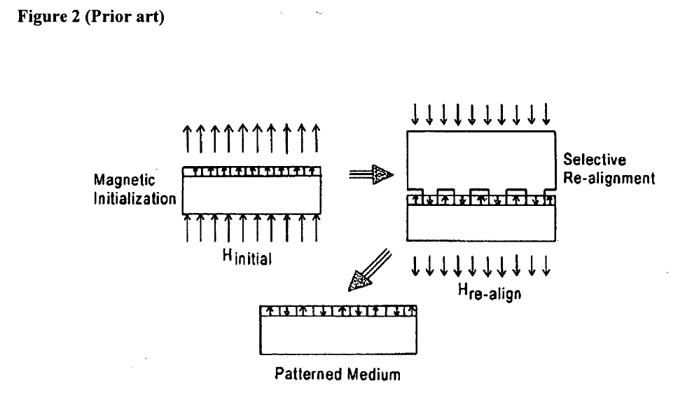

FIG. 3 illustrates, in schematic, simplified cross-sectional view, a similar sequence of process steps for contact printing a magnetic transition pattern in the surface of a longitudinal magnetic recording layer.

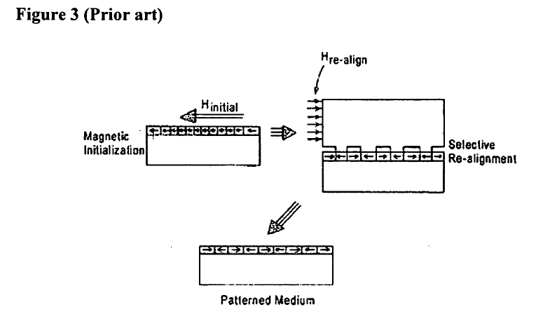

FIG. 4 schematically illustrates, in simplified cross-sectional view, a sequence of steps for forming a magnetic stamper/imprinter for recording media patterning, according to the conventional art.

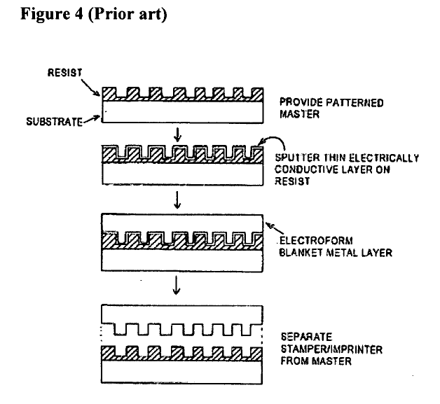

FIG. 5 schematically illustrates an embodiment of an integrated unit having both a particle removal tool and a defect detection/analysis tool combined as one merged tool.

### DETAILED DESCRIPTION

The embodiments of the invention address the problems associated with defect detection and analysis during burnishing without removal of the media from the burnishing (particle removal) tool. These problems were solved by integration of the particle removal tool and the particle detection tool as one merged tool comprising one disc mounting mechanism, plus advanced image processing algorithm. The integrated unit comprises a particle detection tool and a particle removal (burnishing) tool combined as one merged tool comprising a disc mounting mechanism having a mount for mounting the disc for both particle detection and particle removal, wherein the particle detection tool is adapted to distinguish between a void in the disc and a particle on the disc.

The burnishing tool of the embodiments of the invention comprises a burnishing head that sweeps over the surface of the media and removes particles and asperities, for example. Burnishing is achieved, at least in part, by arrangements and methods which provide for the sweeping of the burnishing head across the disc at a skewed angle. A skewing of the arm to which the burnishing head is attached causes the burnishing head to be skewed relative to a disc diameter perpendicular to the sweeping direction, i.e., relative to a surface of the disc (media). This achieves a more complete wiping of loose particles and surface contamination, a more aggressive wedge cutting of asperities and surface conditioning, as well as more efficient particle deflection than conventional non-skewed head burnish arrangements. Employing a burnishing head with a continuous rail edge provides for a wedge cutting that is more, efficient than non-skewed arrangements.

In a burnishing operation, an arm having a burnishing head attached to it at one end is translated in a sweeping direction over the media which is rotated while the arm is translated in such that the head sweeps over the media. The head could be skewed at an angle with respect the surface of the media or it could parallel to the surface of the media. The skewing angle could be between about 5° to about 30° in certain embodiments, between about 10° to about 25° in certain other embodiments and could be between about 15° to about 20° in especially preferred embodiments. The skewed head burnishing could create a more complete wiping action that catches loose particles and surface contaminations.

Another improvement provided by the skewed-head burnishing arrangement is the very aggressive asperity cutting and surface conditioning. For example, the arm could have slider/rail edges that form effective wedges. The aggressiveness of the asperity cutting could be further enhanced with the lower fly height that could be achieved because of the skewing of the burnishing head as there is a less efficient compression of incoming air with a skewed head versus a non-skewed head.

Another improvement produced by the skewed burnishing head arrangement is the deflection action created by the skewed slider/rails. Deflection action prevents loose particles from being embedded into the disc surface. Instead, the particles deflect off the skewed rails. The axes of the rails could be skewed at the skewing angle of about 15° to about 20° with respect to the surface of the disc

The disc is mounted on a mount during burnishing and defect detection/analysis. The mount is rotated by a disc rotation mechanism. The disc rotation mechanism controls the speed of rotation on the disc, which may have an effect on the burnishing with the skewed angle arrangement of the present invention. The disc could be rotated at between about 500 ips to about 1500 ips during the sweeping. In certain embodiments of the invention, the disc could be rotated at about 1100 ips during burnishing and defect detection.

The integrated particle removal and defect detection/analysis unit of the embodiments of this invention isable to perform particle removal and surface defect detection and intermittent disc handling between burnishing and particle removal is eliminated. Also, the embodiments of the invention provide for the distinction between loose particles and non-removable surface defects (mainly voids) in the following way, for example. Perform two defect detection runs before and after the particle removal process and map the defect topography of the media surface before and after the particle removal process. Compare the two defect maps and identify defects that show up on both maps at the same locations on the media surface. These defects are most likely non-removable, void type surface defects. If a disc shows only non-removable defects after the particle removal process, the disc could be accepted for the replication procedure.

An integrated unit having a particle removal tool and an in-situ disc inspection system (“in-situ” meaning that the disc is mounted on the same mount, i.e., a spindle platform, during both the particle removal and in-situ disc inspection) preferably has the following performance specifications:

| Cycle Time | The total cycle time for optical inspection and particle |
|---|---|
| | removal should not exceed 12 seconds. This included data |
| | collection, data processing and disk transport. |
| Particle Detection | The inspection system could be capable of detecting |
| | particles >1.0 micron and above; more preferably >0.5 |
| | micron and above. Particle Removal The particle removal |
| | system could be capable of removing particles >1.0 micron and |
| | above. |
| Particle Detection | The inspection system could be capable of detecting |
| | particles >1.0 micron and above; more preferably >0.5 |
| | micron and above. Particle Removal The particle removal |
| | system could be capable of removing particles >1.0 micron and |
| | above. |
| Automation | The system could interface with an Automated Disk |
| | Handling System. |
| Disk Data & Disposition | Disk information (disk serial number) will be transferred |
| | to the system and at the end of test, processed data and |
| | disk disposition (pass/fail) will be transferred to the |
| | Automated Disk Handling System. Data transfer protocol |
| | and interface TBD. |
| Flexible Sequencing | System control shall be designed to allow flexible |
| | sequencing of test and equipment performance |
| | verification/calibration. |
| Modular Design | System shall be designed in such a way component |
| | modules (i.e., spindles, computers) can be upgraded as |
| | new higher performance modules are made available. |
| System Size | Compact footprint. Ergonomic and serviceable. |
| Cleanroom Compliance | Class 1 compliance in the disk handling zone. Outside of |
| | the Disk Handling Zone, system components shall meeting |
| | Class 100 compliance. |
| Real-Time Operating | For industrial applications |
| System | |
| Disk Form Factor | System could be able to test disk from 95 × 25 mm to |
| | 25 mm × 5 mm. Disk thickness will range from 0.069″ to |
| | 0.015″ |

Additional system specification of the embodiments of the invention could include:

### Maximum cycle time—12 sec (Minimum throughput 300 disc per hour)

### Defect size detection sensitivity—<1 μm

### Disc Laser Index Mark (LIM, which a physical mark on the disk surface to provide disk orientation information during various parts of the media and drive assembly process) detection and alignment within ±5°

### Double-sided detection

### Programmable threshold settings for part rejection

### In-situ defect count, location report for process monitoring/control

### Ext-situ defect count, location mapping for analysis

### Handshaking capability with parent system

### Real-time image comparison capability for pits recognition

### EXAMPLES

Design of the Integrated Particle Removal and Defect Detection/Analysis Tool

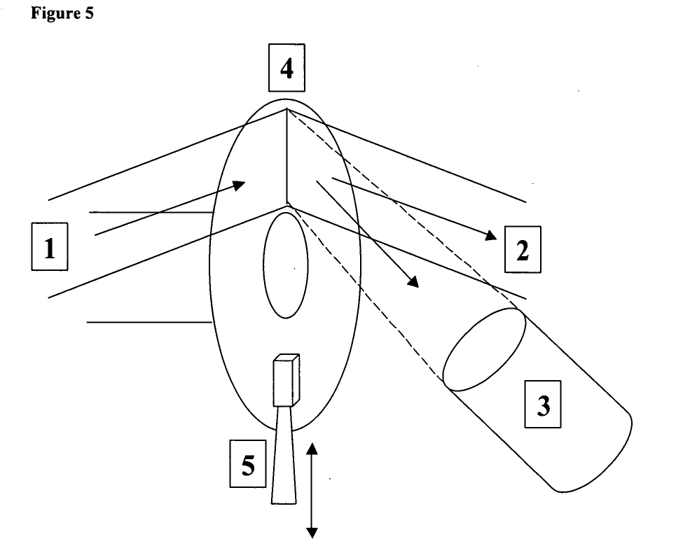

An example of an integrated unit having a merged tool is shown in FIG. 5 in which, a disc is held in a horizontal position (4) on a mount, a burnish head type device (5) is drawn to represent the particle removal setup. There are other methods of particle removal such as tape based buffing process, CO₂ snow, gas (e.g., N₂) jets etc. that can be included depending on the needs and engineering considerations. A linear illumination is incident on the disc surface (1) with reflected beam (2). A detector setup, such as a line scan camera (3), captures scattered light from defects that are illuminated by the incident beam. A wide linear illumination that covers from the disc's inside diameter (ID) to the outer diameter (OD) will allow a full surface coverage with one revolution, warranting a high throughput detection process.

Design of the Optics Module

The defect detection and analysis unit comprises an optics module and a software algorithm module. An embodiment of the optics module. The optics module comprises an incident laser beam that reflects off the surface of the media and the reflected/scattered beam from defects is detected by a detector such as a camera such as a charge coupled device (CCD) camera, a single channel detector or a low-density detector such as a photodiode, a photomultiplier tube, or an avalanche photodiode. The detected signal is then analyzed by the computer software so as to create a defect map of the surface of the media. The optics module can detect particles to 0.1 micron or larger, preferably, 0.5 micron or larger, and most preferably 1 micron or larger, though detection limit is determined mainly by hardware, and further performance enhancement is achievable through the improvement of: (a) incident laser intensity, wavelength, polarization, etc.; (b) numerical aperture (light collecting capability) of the optics; (c) spectral response of the imager (CCD); and reduced noise (electronic, optical).

System Integrator (Software Algorithm) for the Optics Module

The optics module alone can not differentiate fixed media defects from loose particles. It is known from earlier work that fixed defects such as pits, target spits, blisters, handling damage, etc. do not damage the stamper. Rejecting discs having fixed defects leads to over-rejection of the media. To overcome this problem, the embodiments of this invention include a system integrator having software algorithm connected to the optics module. The system integrator compares the optical defect maps before and after particle removal process to differentiate pits from particles. The fixed defects will not be moved by the particle removal process and will show up as the matched defects in the defect maps before and after particle removal while the loose particles will be moved by the head and will show up as the un-matched defects. The system integrator ignores the fixed defects and uses the un-matched defects as a criteria for loose particle detection. While the above examples generally describe defect detection and mapping pre- and post a single burnishing step, it is possible to have multiple burnishing steps with pre- and post burnishing steps for each or some of the burnishing steps.

Method of Manufacturing the Integrated Particle Removal and Defect Detection/Analysis Tool

The manufacturing of the integrated tool would include assembling controller/computer controlling the parameters, motion, sequences, data operation and processing of the particle removal device, the optical inspection system and the disc spindle. This includes, but is not limited to, monitoring safety sensors, communicating to external devices and adhering to SEMI equipment manufacturing safety standards and operations and NFPA standards.

SEMI and other equipment guidelines are described below and incorporated herein by reference.

| Standard | Title | Considerations |
|---|---|---|
| SEMI S2 | EHS Guideline for Semiconductor | SEMI S2 references several other SEMI |
| | Manufacturing Equipment | Guidelines. Additional issues related to |
| | | Section 16 (Ergonomics), Section 21 |
| | | (Environmental Considerations), and Section |
| | | 14 (Fire Protection) |
| SEMI S3 | Safety Guidelines for Heated | |
| | Chemical Baths | |
| SEMI S8 | Safety Guidelines for Ergonomics | |
| | Engineering of Semiconductor | |
| | Manufacturing Equipment | |
| SEMI S11 | EHS Guidelines for Semiconductor | |
| | Manufacturing Equipment Mini- | |
| | Environments | |
| NFPA 70 | National Electrical Code | |
| NFPA 318 | Standard for the Protection of | |
| | Cleanrooms | |
| 21 CFR Part | Safety of Laser Products | CFR is applicable for tools installed in the |
| 1040 | | U.S. EN standard is applicable for tools |
| EN60825-1 | | installed in Europe. Either standard may be |
| | | used for tools installed in Asia. |
| | | Consideration should be given to the |
| | | potential for future tool relocation. |
| NFPA 79 | Electrical Standard for | NFPA is applicable for tools installed in the |
| EN60204-1 | Industrial Machinery | U.S. EN standard is applicable for tools |
| | | installed in Europe. Either standard may be |
| | | used for tools installed in Asia. Consideration |
| | | should be given to the potential for future tool |
| | | relocation. |
| IEC 61010-1 | Safety requirements for | |
| | electrical equipment for | |
| | measurement, control, and | |
| | laboratory use - Part 1: General | |
| | requirements | |

The above description is presented to enable a person skilled in the art to make and invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations that support any range within the disclosed numerical ranges even though a precise range limitation is not stated verbatim in the specification because this invention can be practiced throughout the disclosed numerical ranges. Finally, the entire disclosure of the patents and publications referred in this application are hereby incorporated herein in entirety by reference.

1. An integrated unit comprising a particle detection tool and a particle removal tool combined as one merged tool comprising a disc mounting mechanism having a mount for mounting the disc for both particle detection and particle removal, wherein the particle detection tool is adapted to distinguish between a fixed defect in the disc and a particle on the disc.

2. The integrated unit of claim 1, wherein particle removal tool comprises a burnishing head.

3. The integrated unit of claim 1, wherein the particle removal tool comprises a tape-containing buffing tool.

4. The integrated unit of claim 2, wherein the burnishing head is skewed to a surface of disc.

5. The integrated unit of claim 1, wherein the particle detection tool comprises an optics module and a system integrator comprising software algorithm.

6. The integrated unit of claim 5, wherein the optics module comprises an incident beam generator that directs a beam of light on a surface of the disc and a detector that captures light scattered from the fixed defect in the disc and the particle on the disc.

7. The integrated unit of claim 6, wherein the detector is a line scan camera.

8. The integrated unit of claim 5, wherein the optics module is adapted to detect said fixed defect or said particle having a dimension of about 0.1 micron or more.

9. The integrated unit of claim 5, wherein the system integrator compares optical defect maps of a surface of the disc before and after a particle removal process to distinguish said fixed defect from said particle.

10. The integrated unit of claim 1, further comprising a stamper.

11. The integrated unit of claim 1, wherein the fixed defect is a void, a pit, a target spit, a blister, a scratch, or a handling defect.

12. A method of defect detection and analysis with an integrated unit comprising a particle detection tool and a particle removal tool combined as one merged tool comprising a disc mounting mechanism having a mount for mounting the disc for both particle detection and particle removal, wherein the method comprises mounting the disc on the mount, detecting a fixed defect in the disc and a particle on the disc, and distinguishing between the fixed defect in the disc and the particle on the disc.

13. The method of claim 12, further comprising rotating the disc and sweeping a burnishing heading across a surface of the disc.

14. The method of claim 13, wherein the burnishing head is swept across the surface of the disc at a skewed angle with respect to the surface of the disc.

15. The method of claim 14, wherein the burnishing head is attached to an arm having a central axis, the arm being translated in a sweeping manner and being skewed relative to the surface of the disc.

16. The method of claim 15, wherein the burnishing head is skewed by an angle of between about 5° to about 30°.

17. The method of claim 12, further comprising monitoring a safety sensor, communicating to an external device and adhering to equipment manufacturing safety standards and operations.

18. A method of manufacturing an integrated unit comprising integrating a particle detection tool and a particle removal tool as one merged tool and attaching a disc mounting mechanism having a mount for mounting a disc for both particle detection and particle removal, wherein the particle detection tool is adapted to distinguish between a fixed defect in the disc and a particle on the disc.

19. The method of claim 18, wherein the particle detection tool comprises an optics module comprising an optical inspection system.

20. The method of claim 19, further comprising assembling a controller or computer to control data operation and processing of the particle removal tool, to control the optical inspection system and to control a disc spindle of the disc mounting mechanism.
